(19) United States
(12) Patent Application Publication
(10) Pub. No.: US 2014/0296058 A1
(43) Pub. Date: Oct. 2, 2014

(54) DEHYDROGENATION REACTOR CATALYST COLLECTOR WITH HOT HYDROGEN STRIPPING ZONE

(71) Applicant: UOP LLC, Des Plaines, IL (US)

(72) Inventors: Paul A. Sechrist, South Barrington, IL (US); Laura E. Leonard, Western Springs, IL (US)

(73) Assignee: UOP LLC, Des Plaines, IL (US)

(21) Appl. No.: 14/218,191

(22) Filed: Mar. 18, 2014

Related U.S. Application Data
(60) Provisional application No. 61/805,774, filed on Mar. 27, 2013.

(51) Int. Cl. B01J 38/10

(52) U.S. Cl. CPC B01J 38/10
USPC 502/53; 422/262; 502/34

(57) ABSTRACT

A process and apparatus is presented for the removal of sulfur from a catalyst. The catalyst is a dehydrogenation catalyst, and sulfur accumulates during the dehydrogenation process. The sulfur is removed before the catalyst is regenerated to prevent the formation of undesirable sulfur oxide compounds created during regeneration. The catalyst, during regeneration, includes redispersion of a metal on the catalyst, and removal of sulfur oxides overcomes the interference with chloride retention and metal redispersion in the regeneration process.

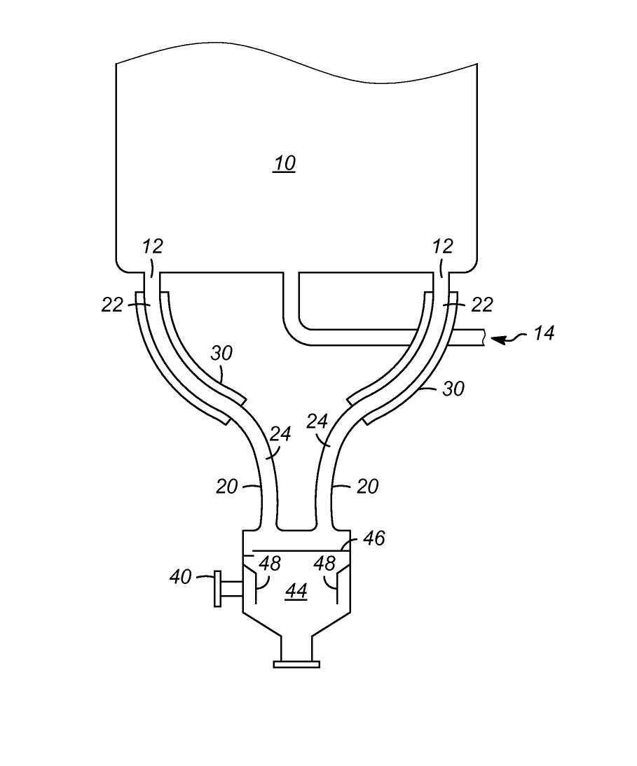

### CROSS REFERENCE TO RELATED APPLICATION

This application claims the benefit of U.S. Provisional Application No. 61/805,774 which was filed on Mar. 27, 2013.

### FIELD OF THE INVENTION

The present invention relates to dehydrogenation processes, and in particular to the process of regeneration of dehydrogenation catalysts.

### BACKGROUND OF THE INVENTION

Light olefins can be produced through the dehydrogenation of light paraffins. The dehydrogenation of paraffins is performed in a catalytic process where a hydrocarbon stream comprising paraffins is contacted with a dehydrogenation catalyst in a reactor under dehydrogenation conditions to generate a light olefin product stream. The catalyst used in this process includes a catalytic metal on a support. The catalytic metal generally comprises a noble metal, such as platinum or palladium. The dehydrogenation process involves many reactions and during the dehydrogenation process, the catalyst is slowly deactivated through the reaction process. One of the contributors to the deactivation is the generation of coke on the catalyst. The catalyst therefore, needs to be periodically regenerated to remain useful in the dehydrogenation process. Due to high temperatures required for the production of light olefins in the dehydrogenation reactors, a low level of H2S must be maintained in the reactor section to prevent the formation of catalyzed coke. In the case of light paraffin dehydrogenation the sulfur level is controlled by directly injecting a sulfur containing compound such as di-methyl di-sulfide into the reactor section with the hydrocarbon feed. Sulfur is known to passivate metal surfaces thus preventing metal catalyzed coke formation. The sulfur can be carried into the regenerator by catalyst and over time impact the catalyst performance. This control and regeneration of a catalyst is important for the lifespan of the catalyst and its usefulness in a catalytic process.

### SUMMARY OF THE INVENTION

The present invention includes an apparatus and process for the regeneration of dehydrogenation catalysts. The apparatus includes catalyst transfer pipes affixed to the catalyst outlets of a catalytic reactor. The catalyst transfer pipes include a stripping section as the catalyst passes through the catalyst transfer pipes. The stripping section includes a heating means to raise the temperature of the stripping section. The apparatus further includes a stripping gas inlet, for admitting a stripping gas to the catalyst transfer pipes, and to flow over the catalyst passing through the catalyst transfer pipes.

In another embodiment, the invention includes the process of stripping a catalyst of sulfur compounds deposited on the catalyst during the catalytic process. In particular, the catalytic process is the dehydrogenation of a hydrocarbon, and the catalyst comprises a platinum group metal on a support. The process includes passing spent catalyst from a reactor to a catalyst transfer pipe. The catalyst transfer pipe includes a heated stripping zone where the catalyst is heated. A stripping gas is passed over the catalyst to remove sulfur compounds on the catalyst as the catalyst passes through the stripping zone to generate a sulfur stripped spent catalyst. The catalyst is then passed to a cooling zone in the catalyst transfer pipes to reduce the catalyst temperature for the protection of downstream valves from thermal stresses. The catalyst is passed from the catalyst transfer pipe to a catalyst collector for further transfer to a regenerator.

Other objects, advantages and applications of the present invention will become apparent to those skilled in the art from the following detailed description and drawings.

### BRIEF DESCRIPTION OF THE DRAWING

The FIGURE is a schematic of the design and process for stripping sulfur from spent catalyst.

### DETAILED DESCRIPTION OF THE INVENTION

Catalysts are very sensitive to poisons, and are very expensive. Catalysts are among the most expensive items in a petrochemical plant, and maintaining catalysts contributes to significant savings in a process. A typical catalyst is used in a process and over time deactivates. The catalyst is regenerated, or reactivated, by passing the catalyst from a reactor to a regenerator. In many petrochemical processes, the regeneration comprises burning off carbon that has deposited on the catalyst during the catalytic process. In addition, other components such as sulfur compounds also deposit on the catalyst. The catalyst can also include precious metals, such as platinum, and the presence of sulfur interferes with the regeneration step where the platinum is redispersed.

The dehydrogenation process of alkanes for the production of olefins utilizes a catalyst that incorporates platinum, or other metals from the platinum group. As used hereinafter, reference to platinum also is intended to include metals in the platinum group. During the regeneration of a dehydrogenation catalyst, sulfur is burned off and forms at least sulfite, sulfate and sulfur dioxide. The sulfate interferes with the chloride retention on the catalyst and ultimately interferes with a proper redispersion of the active metal, or platinum.

It has been found that the sulfur can be stripped from the catalyst prior to regeneration in a reducing envirionment, and that this can occur in a relatively short time at a modestly elevated temperature. The present invention comprises passing a spent catalyst stream from a reactor to a catalyst transfer pipe. A sulfur stripping gas is passed through the catalyst transfer pipe to contact the catalyst in the transfer pipe and to create a sulfur stripping zone to generate a sulfur stripped spent catalyst. The sulfur stripped spent catalyst is passed to a regenerator to create a regenerated catalyst stream, and the regenerated catalyst stream is returned to the reactor.

In the dehydrogenation process of light olefins, the process often utilizes a plurality of reactors, where catalyst is passed in a series manner from one reactor to a subsequent reactor in the series. The dehydrogenation process is endothermic, and cools the reactants and the catalyst as the reaction proceeds. In between each pair of reactors is a heater, or heat exchanger, to reheat catalyst as the catalyst is passed from one reactor to the next reactor. The process stream can also be reheated to bring the reaction process up to a desired temperature. The catalyst as it exits the last reactor is then passed to a regenerator for re-activating the catalyst.

The stripping section of the catalyst transfer pipe is heated to a temperature greater than about 150° C., preferably greater than 250° C., and most preferably greater than about 300° C. The stripping section is heated to between 150° C. and 700° C., preferably 250° C. and 650° C., and more preferably between 250° C. and 350° C. The sulfur stripping gas is passed through the stripping zone in the catalyst transfer pipes, and comprises an H2S-free gas. The stripping gas is passed through the stripping zone at a rate equivalent to a gas hourly space velocity (GHSV) of at least 100 hr⁻¹, and preferably between 100 hr⁻¹ and 1000 hr⁻¹, and more preferably between 200 hr⁻¹ and 700 hr⁻¹, and most preferably between 200 hr⁻¹ and 300 hr⁻¹. The gas can be a sulfur free gas. The stripping zone is a reducing zone and the sulfur free gas is hydrogen rich containing at least 50 mol % hydrogen, preferably>80 mol % hydrogen, and more preferably>90 mol % hydrogen. The stripping zone is operated under reducing conditions to convert sulfur compounds on the catalyst to gaseous compounds comprising sulfur, such as H2S. The section of the catalyst transfer pipe for the stripping zone is sized to maintain a spent catalyst residence time of at least 20 minutes. In a preferred mode, the catalyst residence time in the stripping zone is between 20 minutes and 1 hour. In a more preferred mode, the catalyst residence time in the stripping zone is between 20 minutes and 30 minutes.

The catalyst is then passed in the catalyst transfer pipe from the heated stripping section to a cooling zone. The stripping gas passes through the cooling zone and over the catalyst prior to passing into the stripping zone, and in the stripping zone the catalyst and the stripping gas are heated. The stripping gas is passed through the catalyst transfer pipe at a flow rate low enough to maintain an upward pressure gradient of less than 2.25 kPa/m. This allows the gas to flow upward, while allowing the catalyst to flow downward through the catalyst transfer pipe.

The catalyst is further passed to a regenerator, where the carbon deposited on the catalyst is burned off. The catalyst is further processed for platinum metal redispersion.

One aspect of the invention is an apparatus for stripping sulfur compound from a catalyst. The apparatus strips the sulfur from the catalyst prior to the passing of the catalyst to a regenerator. The apparatus, as shown in the FIGURE, comprises attachments to a dehydrogenation reactor 10. The dehydrogenation reactor 10 has a catalyst inlet, a catalyst outlet 12, a hydrocarbon inlet 14 and a product outlet. The apparatus includes at least one catalyst transfer pipe 20 affixed to the catalyst outlet 12. The catalyst transfer pipes 20 include a heating means 30 for heating a section 22 of the catalyst transfer pipes 20. The apparatus further includes a stripping gas inlet 40 positioned downstream of the catalyst transfer pipes 20. One skilled in the art will understand that additional equipment may be present downstream of the catalyst collector 44 to control catalyst movement, such as valves, vessels for holding catalyst, piping and lock hoppers.

The catalyst transfer pipes 20 include a cooling section 24 downstream of the stripping section 22. The catalyst is cooled in the cooling section to protect a downstream lock hopper and associated valve from thermal stresses. In one embodiment, the apparatus can include a catalyst collector 44 in fluid communication with the catalyst transfer pipes 20, and upstream of the lock hopper. The catalyst collector can include baffles 46 for distributing the catalyst from the transfer pipes 20, and baffles 48 for distributing the stripping gas over the catalyst from the catalyst transfer pipes 20.

The heating means 30 can comprise electrical heat traces that are wrapped around the stripping section 22 of the catalyst transfer pipes 20. Other means of heating the stripping section 22 can include tubing, wrapped around the pipes, and carrying stream or other heating fluids for heating the stripping section. 22.

This apparatus can be retrofitted to existing dehydrogenation reactor units, where the piping between the reactor and a catalyst collector or lock hopper are replaced with appropriately sized catalyst transfer pipes and with heat traces around the transfer pipes.

One aspect that enables this apparatus is that the volume of catalyst collector pipes upstream of the catalyst collector is determined by the volume flow of the gas required to cool the catalyst. This cooling gas can perform the double duty of cooling and stripping the catalyst of sulfur before the catalyst enters the lock hopper. The catalyst transfer pipes are therefore, sized to allow for sufficient sulfur stripping gas to cool the catalyst after the stripping of sulfur, and to have a catalyst residence time within the stripping section between 20 min. and 1 hour.

The cooling section of the catalyst transfer piping can be as short as 0.3 meters, as it has been found that the catalyst is rapidly cooled over a short section of piping. The catalyst collector provides the surge during the lock hopper cycle. A lock hopper system is for the transfer of catalyst and involves passing amounts of catalyst between zones, such as between the reactor and the regenerator.

While the invention has been described with what are presently considered the preferred embodiments, it is to be understood that the invention is not limited to the disclosed embodiments, but it is intended to cover various modifications and equivalent arrangements included within the scope of the appended claims.

1. A process for the regeneration of spent catalyst comprising:
passing the spent catalyst to a catalyst transfer pipe, and passing a sulfur stripping gas through the catalyst transfer pipe, thereby creating a sulfur stripping zone to generate a sulfur stripped spent catalyst; and
passing the sulfur stripped spent catalyst to a regenerator to create a regenerated catalyst stream.

2. The process of claim 1 wherein the stripping zone is heated.

3. The process of claim 2 wherein the stripping zone is heated to a temperature between 150° C. and 700° C.

4. The process of claim 1 further comprising passing a stripping gas comprising a sulfur free gas through the stripping zone.

5. The process of claim 4 wherein the sulfur free gas is hydrogen rich.

6. The process of claim 4 further comprising passing the stripping gas over the catalyst in a cooling zone prior to passing the stripping gas to the stripping zone.

7. The process of claim 4 wherein the stripping gas is passed at a flow rate low enough to maintain the upward pressure gradient in the catalyst transfer pipe to be less than 2.25 kPa/m.

8. The process of claim 1 wherein the sulfur stripping zone is under reducing conditions.

9. The process of claim 1 wherein the spent catalyst has a residence time in the stripping zone is at least 20 minutes.

10. The process of claim 9 wherein the spent catalyst has a residence time in the stripping zone from 20 min to 1 hour.

11. The process of claim 1 wherein the stripping gas is passed through the stripping zone at a gas hourly space velocity of at least 100 hr⁻¹.

12. A process for the regeneration of spent dehydrogenation catalyst comprising:
passing the spent dehydrogenation catalyst through a heated stripping section to generate a stripped spent catalyst;
passing the stripped spent catalyst through a cooling zone to generate a cooled stripped spent catalyst;
passing the cooled stripped spent catalyst to a catalyst collection zone;
passing a sulfur-free gas through the cooling zone; and
passing the sulfur-free gas through the stripping section to strip sulfur compounds from the spent catalyst.

13. The process of claim 12 further comprising passing the stripped, cooled catalyst to a catalyst regenerator.

14. The process of claim 12 further comprising passing the sulfur-free gas through the catalyst collection zone prior to passing the gas to the cooling zone.

15. An apparatus for the stripping of residual sulfur from a catalyst comprising:
a dehydrogenation reactor having a catalyst inlet, a catalyst outlet, a hydrocarbon inlet and a product outlet;
catalyst transfer pipes affixed to a catalytic reactor having a catalyst stripping section, at the catalyst outlet;
a heating means for heating the catalyst transfer pipes; and
a stripping gas inlet affixed downstream of the catalyst transfer pipes, and in fluid communication with the catalyst transfer pipes.

16. The apparatus of claim 15 further comprising a cooling section in the catalyst transfer pipes downstream of the catalyst stripping section.

17. The apparatus of claim 15 further comprising a catalyst collector, in fluid communication with the catalyst transfer pipes, and upstream to a lock hopper.

18. The apparatus of claim 17 wherein the catalyst collector includes baffles for distributing the catalyst from the catalyst transfer pipes and for distributing the stripping gas over the catalyst.

19. The apparatus of claim 15 wherein the heating means comprises electrical heat traces around the catalyst transfer pipes for the catalyst stripping section.

20. The apparatus of claim 15 wherein the heating means comprises heat tracing around the catalyst transfer pipes.
